(19) United States
(12) Patent Application Publication
(10) Pub. No.: US 2017/0367306 A1
(43) Pub. Date: Dec. 28, 2017

(54) ANIMAL FEEDER WITH MAGNETIC COMPONENTS

(71) Applicant: APOLLO INVESTMENT HOLDING CO., LLC, Juneau, WI (US)

(72) Inventors: Keith W. McCord, Florissant, MO (US); Kenneth R. Hepp, Oconomowoc, WI (US); Thomas J. Green, West Bend, WI (US)

(21) Appl. No.: 15/317,678

(22) PCT Filed: Mar. 17, 2016
(86) PCT No.: PCT/US16/22914

§ 371 Date: Dec. 9, 2016

Related U.S. Application Data
(60) Provisional application No. 62/134,356, filed on Mar. 17, 2015.

(51) Int. Cl. A01K 39/012; A01K 5/02

(52) U.S. Cl. CPC A01K 39/012; A01K 5/0225

(57) ABSTRACT

The invention provides, in one aspect, an animal feeder. The animal feeder includes a base and a sidewall extending upward from the base. The sidewall and base at least partially define an inner cavity operable to hold an animal feed. A roof, operable to transition between an open position and a closed position, is located above the sidewall. In the open position, the roof is magnetically attached to a first magnetic feature such that a user can access the inner cavity. In the closed position, the roof is magnetically attached to a second magnetic feature such that the user cannot access the inner cavity.

### FIELD OF THE INVENTION

The present invention relates to animal feeders. More particularly, the invention relates to bird feeders.

### SUMMARY OF THE INVENTION

The invention provides, in one aspect, an animal feeder. The animal feeder includes a base and a sidewall extending upward from the base. The sidewall and base at least partially define an inner cavity operable to hold an animal feed. A roof, operable to transition between an open position and a closed position, is located above the sidewall. In the open position, the roof is magnetically attached to a first magnetic feature such that a user can access the inner cavity. In the closed position, the roof is magnetically attached to a second magnetic feature such that the user cannot access the inner cavity.

The invention provides, in another aspect, an animal feeder. The animal feeder includes a base including a magnetic feature and a sidewall extending upward from the base and including a magnetic feature. The sidewall and base at least partially define an inner cavity operable to hold an animal feed. The magnetic feature is selectively, magnetically attached to the second magnetic feature.

The invention provides, in yet another aspect, an animal feeder. The animal feeder includes a base, a first sidewall including a first magnetic feature and extending upward from the base, and a second sidewall including a second magnetic feature and extending upward from the base. The sidewall and base at least partially define an inner cavity operable to hold animal feed. The first magnetic feature is magnetically attached to the second magnetic feature.

Other aspects of the invention will become apparent by consideration of the detailed description and accompanying drawings.

### BRIEF DESCRIPTION OF THE DRAWINGS

FIG. 1 is an exploded view of an animal feeder.

FIG. 2 is a partial cross-sectional view of a corner of the assembled animal feeder of FIG. 1 from above.

FIG. 3 is a partial cross-sectional view of the assembled animal feeder of FIG. 1 from a side.

FIG. 4 is a partial cross-sectional view of an animal feeder in a second embodiment.

FIG. 5 is a partial cross sectional view of a roof assembly of an animal feeder.

FIG. 6A is a side view of the roof assembly of FIG. 5 in an open position relative to the animal feeder.

FIG. 6B is a side view of the roof assembly of FIG. 5 in a closed position relative to the animal feeder.

FIG. 7 is a cutaway perspective exploded view of an animal feeder with a rotatable roof panel.

FIG. 8 is a partial front view of the animal feeder of FIG. 7 with the roof panel in an open position.

FIG. 9 is a partial front view of the animal feeder of FIG. 7 with the roof panel in a closed position.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

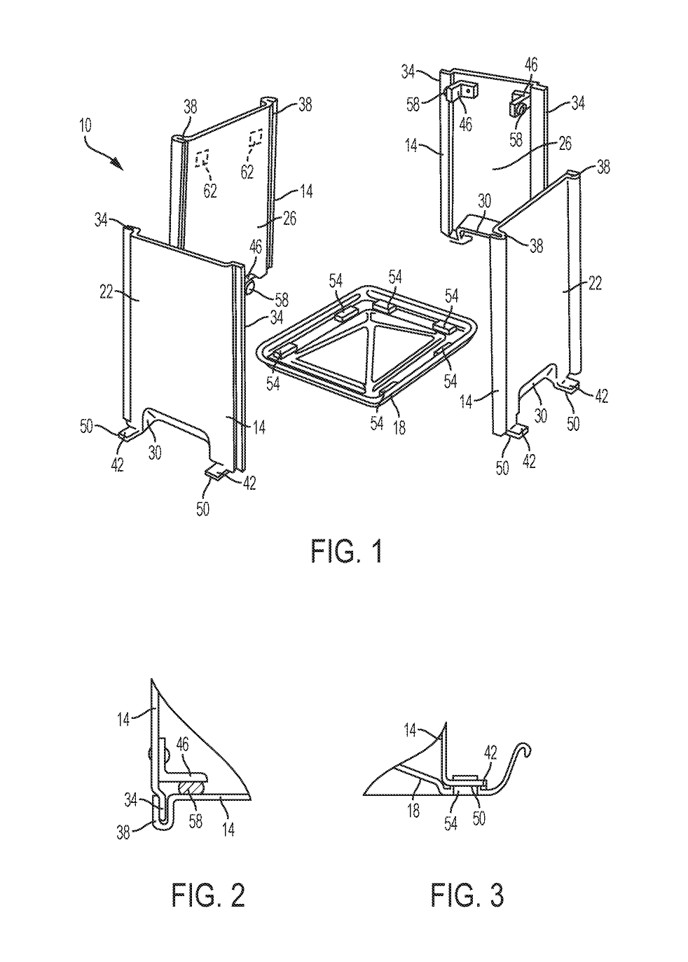

FIG. 1 is an exploded view of an animal feeder 10 according to some embodiments of the invention. As shown, the feeder 10 includes a plurality of side panels 14 and a base 18. The feeder 10 may further include a roof and a hanging cord such as a cable, string, rope, or wire, though these are not shown with respect to FIG. 1. When assembled, the side panels 14 have an exterior surface 22 which faces outward, and an interior surface 26 which faces inward. The side panels 14 include an opening which functions as a feed port 30 by which feed within the feeder 10 can be accessed by small animals, such as birds. As shown, each panel 14 includes an opening 30, however, in other embodiments, not every panel 14 may include an opening (e.g., only one opening per feeder, one opening on every other panel, etc.). As shown in more detail in FIG. 3, the base 18 includes a perch 20 for the animal to rest upon which may be continuous about the perimeter of the feeder 10, or may correspond to the individual feed ports 30.

When assembled, the side panels 14 have a square cross-section, with the side panels 14 extending upward vertically from the base 18 when the feeder 10 is hanging in a position of use. It should be appreciated, however, that in other embodiments, the side panels 14 may have circular, triangular, pentagonal, hexagonal and other cross-sections with corresponding numbers of vertical faces. Collectively, the assembled side panels 14 form a sidewall. The sidewall extends upward from the base 18, and in combination with the base 18, defines an inner cavity operable to hold the animal feed.

The panels 14 include various alignment features 34, 38 where one panel 14 interacts with another panel 14. This interaction is shown in FIG. 2. As shown, the alignment features 34, 38 include alignment of a tongue 34 and groove 38 to position one panel 14 with another. As shown, opposing panels 14 include two each of either tongues 34 or grooves 38. Alternatively, each panel can include one each of a tongue 34 and a groove 38.

In addition to the alignment features 34, 38, the panels 14 include a plurality of flanges 42, 46 extending from the panels 14 in various locations. First flanges 42, as shown in FIG. 1 and FIG. 3, extend outward from the base of each panel 14 (i.e., the end in contact with the base 18 when assembled) and contain a magnet or magnetic surface 50 in facing relation to the base 18 when assembled. The magnets 50 interact with a corresponding magnet or magnetic surface 54 of the base 18 to secure the panels 14 to the base 18.

Second flanges 46, located away from the base of the panel 14, as shown, are located on the panels 14 which include alignment tongues 34. Each second flange 46 includes a magnet or magnetic surface 58 which aligns with a magnet or magnetic surface 62 on the interior surface 26 of the panels 14 which include alignment grooves 38. The alignment grooves 38 prevent the panels 14 with alignment tongues 34 from falling outward when the feeder 10 is assembled. The magnets 58 associated with the second flanges 46 prevent the panels 14 with alignment grooves 38 from falling outward when the feeder 10 is assembled. Collectively, the tongues 34, grooves 38, and magnetic surfaces 58, 62 hold and fix each panel 14 relative to each adjacent panel 14. Alternatively, if each panel included one tongue 34 to mate with a groove 38 of an adjacent panel 14 and one groove to mate with a tongue of an adjacent panel 14, the second flanges 46 may be omitted.

The flanges 42, 46 may be integral with the sidewalls, or may be attached by a known attachment means (e.g., adhesive, rivets, fastener, etc.). Further, the various magnets 50, 54, 58, 62 may be attached (e.g., adhesively bonded, etc.) to the corresponding surfaces, or may be integral with the surfaces (i.e., the corresponding surfaces may be magnetic themselves).

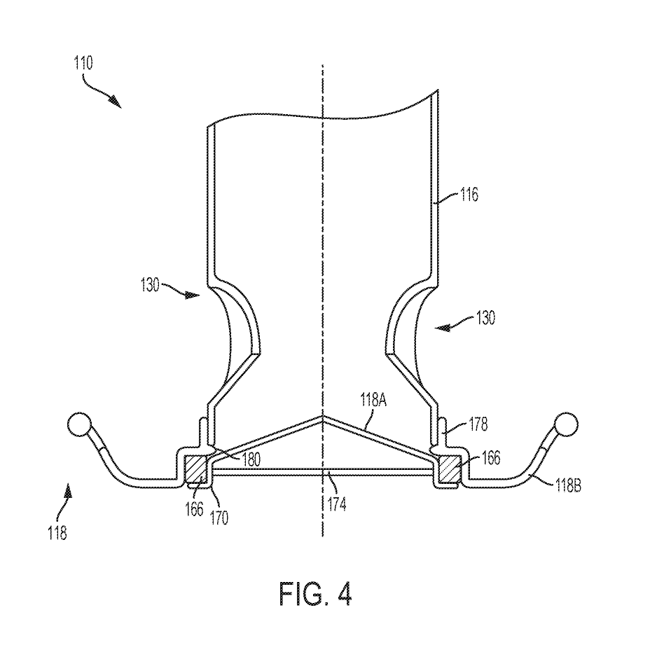

With respect to FIG. 4, like features are identified with like reference numerals incremented by one-hundred and will not be discussed in further detail. The animal feeder 110 of FIG. 4 includes a tubular or cylindrical sidewall 116, as opposed to the four flat panels 14 of FIG. 1. Two feed ports 130 are integral with the sidewall 116 and permit a small animal, such as a bird, to access the feed within. The base 118 of the birdfeeder 110 includes two components: a central panel 118A and a perch 118B.

The central panel 118A is the base of the inner cavity which is operable to hold the animal feed. As shown, extending around the periphery of the central panel 118A is an L-shaped flange 170. The L-shaped flange 170 supports a magnet 166 (or multiple magnets). The central plate 118A may be made of a magnetic material (e.g., steel, iron, nickel, etc.) or may include magnets to align with the magnet 166. The magnet 166 may be fixed (i.e., adhered) to the central panel 118A, may be fixed (i.e., adhered) to the perch 118B, or if both the central panel 118A and the perch 118B are made of magnetic materials, the magnet 166 may not be fixed to either of the base components 118A, 118B. The central panel 118A includes a pull handle 174 which allows a user to magnetically remove the central panel 118A from the animal feeder 110 and easily clean the inside of the animal feeder 110.

The perch 118B may be made out of a magnetic material or a non-magnetic material. It includes a tubular lip 178 which supports the cylindrical sidewall 116 and fixes the sidewall 116 to the base 118. A second lip 180 acts a stopper to prevent the sidewall 116 from contacting the central panel 118A. This prohibits the assembly of the sidewall 116 and the perch 118B from magnetically disconnecting the central panel 118A from the perch 118B. The perch 118B further includes an L-shaped flange 182 which mates with the magnet 166 in a similar manner to the L-shaped flange 166. The portion of the perch 118B upon which a small animal rests extends outward from the animal feeder sidewall 116. This portion may be continuous and wrap about the entirety of the sidewall, or a plurality of individual perches may be located at each of the feed ports 130.

Although shown with reference to a second embodiment of an animal feeder 110, the magnetic base assembly 118, 166 may be used in combination with the magnetically mated side panels 14 of FIGS. 1-3.

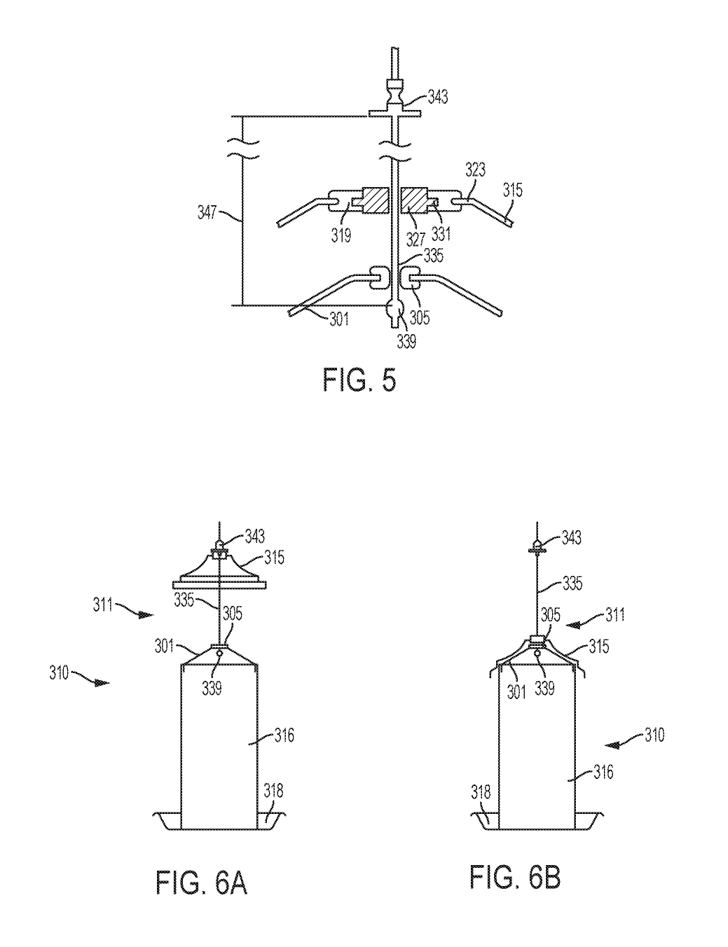

With respect to FIGS. 5-6B, like features are identified with like reference numerals incremented by two-hundred and will not be discussed in further detail. FIG. 5 focuses on a roof assembly 311 of an animal feeder 310. The roof assembly 311 includes a cross bar 301 which is fixed to the sidewall 316 at two locations opposite one another. The cross bar 301 features a centrally located orifice which is partially filled with a magnetic rivet 305 (e.g., a steel tube rivet). The rivet 305 contains a central hole through which a hanging cord 335 (e.g., cable, string, rope, or wire) extends.

The roof assembly 311 further includes a roof panel 315 which, when in a closed position (FIG. 6B) covers an opening atop the sidewall 316 and covers the cross bar 305. The roof panel 315 includes a centrally located grommet 319 (e.g., plastic grommet) which is fixed to the roof panel 315 via a first groove 323. A magnet 327 extends into a second groove 331 in the grommet 319 and is thereby fixed to the roof panel 315 via the grommet 319. The magnet 327 includes a central orifice through which the hanging cord 335 extends.

The hanging cord 335 includes a proximal end that, when assembled, is below the roof panel 315 and a distal end which extends above and outward from the roof panel 315. At the distal end (not shown) of the hanging cord 335 is an attachment feature (e.g., hook, loop, etc.) for hanging the bird feeder from an outside feature (e.g., tree branch, post, etc.). When the animal feeder 310 is hung from an outside feature, the hanging cord 335 is taut, and the bird feeder is supported by the hanging cord 335. The hanging cord 335 includes a stopper 339 located at the distal end of the cord 335. The stopper 339 has a diameter which is greater than a diameter of the hole of the rivet 305 such that, when the hanging cord 335 extends through the rivet 305, the stopper 339 does not. Therefore, when the cord 335 is taut, the stopper abuts the rivet 305, thereby supporting the entirety of the animal feeder 310.

The hanging cord 335 further includes a magnetic feature or upper stopper 343 fixed (e.g., crimped) to the hanging cord 335. The upper stopper 343 is made of a magnetic material, or at least includes a magnetic surface in facing relation to the magnet 327. The upper stopper 343 is fixed to the hanging cord 335 a distance 347 away from the stopper 339. When the stopper 339 abuts the rivet 305 and the magnet 327 abuts the upper stopper 343, the distance 347 is great enough to allow a user to access feed inside of the animal feeder 310 and provide feed to the animal feeder 310 via the opening atop the sidewall 316.

The roof assembly 311 is operable to transition between an open position (FIG. 6A) and a closed position (FIG. 6B). In the open position, the magnet 327, which is fixed to the grommet 319 and the roof panel 315, is magnetically attached to the upper stopper 343. This provides user access to the inside of the animal feeder 310 without necessitating the user to hold up the roof panel 315. In the closed position, the magnet 327, which is fixed to the grommet 319 and the roof panel 315, is magnetically attached to the rivet 305. This fixes the roof panel 315 over the opening atop the sidewall 316 and prevents access to the feed via the opening. This may additionally prevent an animal, such as a squirrel from accessing the feed via the opening. In order to transition from the open position to the closed position, the user must overcome the magnetic attraction between the magnet 327 and the upper stopper 343. In order to transition from the closed position to the open position, the user must overcome the magnetic attraction between the magnet 327 and the rivet 305.

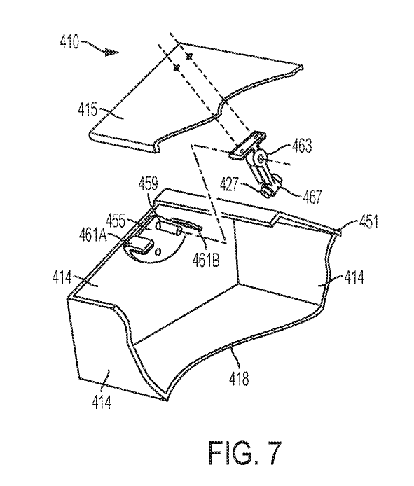

With respect to FIGS. 7-9, like features are identified with like reference numerals incremented by one-hundred and will not be discussed in further detail. FIG. 7 shows an exploded partial perspective view of an animal feeder 410. The animal feeder 410 is pentagon-shaped when viewed from the front (i.e., the side removed for the cutaway), with an inverted “V”-shaped roof 415, 451. The animal feeder includes a plurality of side panels 414, which may be separate panels 414 (e.g., employing the magnetic features of FIGS. 1-3) or may be formed as a single panel 414. As shown, the base 418, the side panels 414 and a fixed roof panel 451 are integrally formed with one another. Roof panel 415, unlike fixed roof panel 451, is not integrally formed with or fixed to the side panels 414 and the base 418.

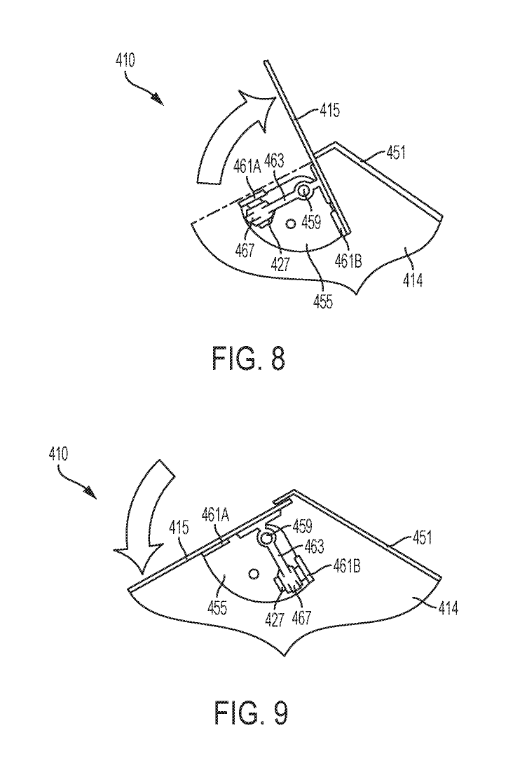

A bracket 455 is fixed to one of the sidewalls 414 (as shown in FIG. 7, the bracket is fixed to a rear wall, opposite the front wall) via a fastener (not shown) or an alternative fixing means (e.g., adhesive, etc.). The bracket 455 includes a post 459, a first flange 461A, and a second flange 461B, all of which extend outward from and perpendicular to the sidewall 414 upon which the bracket 455 is affixed. The flanges 461A, 461B are magnetic, or at least include a magnetic surface. The flanges 461A, 461B will be described in more detail with respect to FIGS. 8-9 below.

The post 459 is cylindrical and marks a center of rotation for an arm 463 which includes an orifice operable (i.e., appropriately sized) to mate with the post 459. The arm 463 is fixed to the roof panel 415 via a fastener (not shown) or an alternative fixing means (e.g., adhesive, set screw, etc.). Opposite the end of the arm 463 fixed to the roof panel 415 is a housing 467 with an orifice which supports a magnet 427. As shown, the magnet 427 extends through the housing 467 of the arm 463 such that the magnet 427 protrudes from both sides of the housing 467. Alternative to the single magnet 427 extending through the housing 467, the housing 467 may include two recesses opposite one another and two magnets may be fitted into and protrude outward from the recesses.

The roof panel 415 is operable to transition between an open position (FIG. 8) and a closed position (FIG. 9). In the open position, the roof panel 415 is in a position in which a user can access the inside of the animal feeder 410. As the arm 463 is fixed to the roof panel 415, the roof panel 415 and the arm 463 rotate about the post 459 which is fixed to a sidewall 414. When in the open position, the magnet 427 in the housing 467 of the arm 463 is magnetically attached to a magnetic surface of the first flange 461A. In this position, the roof is parallel to the second flange 461B. The magnetic attraction between the first flange 461A and the magnet 427 holds the roof in the open position such that a user can access the inside of the animal feeder 410 to add feed or clean the inside.

In the closed position, the roof panel 415 is in a position in which a user cannot access the inside of the animal feeder 410. When in the closed position, the magnet 427 in the housing 467 of the arm 463 is magnetically attached to a magnetic surface of the second flange 461B. In this position, the roof is parallel to the first flange 461B. The magnetic attraction between the second flange 461B and the magnet 427 holds the roof in the closed position such that an animal, such as a squirrel cannot access the inside of the animal feeder 410.

It should be appreciated that the various features associated with the embodiments of FIGS. 1-9 may be variously combined within the scope of the invention.

1. An animal feeder comprising:
a base;
a sidewall extending upward from the base, the sidewall and base at least partially defining an inner cavity operable to hold an animal feed; and
a roof, operable to transition between an open position and a closed position and located above the sidewall,
wherein, in the open position, the roof is magnetically attached to a first magnetic feature such that a user can access the inner cavity, and
wherein, in the closed position, the roof is magnetically attached to a second magnetic feature such that the user cannot access the inner cavity.

2. The animal feeder of claim 1, further comprising a cord operable to support the inner cavity, wherein the roof is movable along the cord and wherein the first magnetic feature is provided on the cord.

3. The animal feeder of claim 2, further comprising a cross bar that extends across the inner cavity, wherein the cord extends through the cross bar and the second magnetic feature is provided on the cross bar.

4. The animal feeder of claim 2, wherein the first magnetic feature is crimped to the cord to fix the first magnetic feature axially relative to the cord.

5. The animal feeder of claim 1, wherein the roof includes a roof panel, an annular grommet and an annular magnet, and wherein the roof panel is fixed to the annular grommet and the annular grommet is fixed to the annular magnet.

6. The animal feeder of claim 5, wherein the annular magnet is magnetically attached to the first magnetic feature when the roof is in the open position and is magnetically attached to the second magnetic feature when the roof is in the closed position.

7. The animal feeder of claim 5, further comprising a cord operable to support the inner cavity, wherein the cord extends through the annular magnet.

8. The animal feeder of claim 1, wherein the roof is a first roof panel, and further comprising a second roof panel fixed relative to the sidewall to at least partially define the inner cavity.

9. The animal feeder of claim 8, wherein the first roof panel is attached to a first end of an arm, wherein a second end of the arm is provided with a magnet, and wherein the arm includes an aperture between the first end and the second end.

10. The animal feeder of claim 9, further comprising a bracket fixed to the sidewall, wherein the bracket includes a post, the first magnetic feature and the second magnetic feature, wherein the post extends into the aperture and the arm rotates about the post.

11. An animal feeder comprising:
a base including a magnetic feature; and
a sidewall extending upward from the base and including a second magnetic feature,
wherein the sidewall and base at least partially define an inner cavity operable to hold an animal feed, and
wherein the first magnetic feature is selectively, magnetically attached to the second magnetic feature.

12. The animal feeder of claim 11, wherein the sidewall is a first sidewall, and further comprising a second sidewall, wherein the second sidewall partially defines the inner cavity, wherein the first sidewall is provided with a third magnetic feature and the second sidewall is provided with a fourth magnetic feature, the third magnetic feature magnetically attached to the fourth magnetic feature.

13. The animal feeder of claim 12, wherein the first sidewall includes a tongue and the second sidewall includes a groove, wherein the tongue extends into the groove to orient the first sidewall relative to the second sidewall such that the third magnetic feature is adjacent to the fourth magnetic feature.

14. The animal feeder of claim 11, wherein the base further includes a pull handle located below the inner cavity to allow decoupling of the first magnetic feature from the second magnetic feature.

15. The animal feeder of claim 11, wherein the sidewall includes a flange extending outside of the inner cavity, and wherein the second magnetic feature is fixed to the flange.

16. An animal feeder comprising:
a base;
a first sidewall including a first magnetic feature, the first sidewall extending upward from the base; and
a second sidewall including a second magnetic feature, the second sidewall extending upward from the base;
wherein the sidewall and base at least partially define an inner cavity operable to hold an animal feed, and
wherein the first magnetic feature is magnetically attached to the second magnetic feature.

17. The animal feeder of claim 16, wherein the first sidewall includes a flange that extends within the inner cavity and supports the first magnetic feature.

18. The animal feeder of claim 16, wherein the first sidewall includes a tongue and the second sidewall includes a groove, wherein the tongue extends into the groove to orient the first sidewall relative to the second sidewall such that the first magnetic feature is adjacent to the second magnetic feature.

19. The animal feeder of claim 18, wherein each of the tongue and groove extend upward from the base.

20. The animal feeder of claim 16, wherein each of the first sidewall and the second sidewall includes a feed port providing access to the animal feed within the inner cavity, and wherein each feed port is located between the first magnetic feature and the base.
